(19) United States
(12) Patent Application Publication
(10) Pub. No.: US 2011/0188919 A1
(43) Pub. Date: Aug. 4, 2011

(54) ROLLER FOR PAINTING DIFFICULT-TO-ACCESS ROUGH SURFACES

(76) Inventor: Carlos Saravia Castillon, Durango (MX)

(21) Appl. No.: 12/918,446

(22) PCT Filed: Mar. 6, 2008
(86) PCT No.: PCT/MX08/00038

§ 371 Date: Aug. 19, 2010

(51) Int. Cl. B43K 7/10

(52) U.S. Cl. 401/147

(57) ABSTRACT

The invention relates to an improved roller for painting difficult-to-access rough surfaces, comprising a roller formed by a tube, one end of which is provided with perforations from which the paint is released in order to wet a plush roller disposed at said end. Each end of the plush roller is provided with a pierced cover having a central perforation through which the tube extends and a rough section which provides grip when a cover is being installed or removed. The invention also includes an open half-pipe casing including at least one perforation on each side thereof, through which the tube extends, and a V-channel at the longitudinal edges thereof, into which bristles are inserted. In addition, an extendable/retractable handle is added to the lower part of the base of the tube.

### FIELD OF THE INVENTION

The present invention relates to the technical field of construction, specifically to tools for painting, such as rollers and brushes. Specifically, it provides an improved paint roller, with an extensible and/or retractable handle, for rough and elevated surfaces.

### BACKGROUND OF THE INVENTION

One of the main problems in the field of construction paint, is the difficult access to paint high and rough surfaces, either with a roller and brush. To this end, the painter has to climb up to the elevated surface and paint several layers until the surface is completely covered, which results in the use of tools to climb up, larger quantity of paint, more effort by the painter and the risk of falls.

The document ES 1002613 U, describes an improved paint roller, which is made up of a body-casing that constitutes itself or incorporates a storage tank of paint and a hand grip, able to be connected to an optional auxiliary handle; at least one impregnation impeller mounted with the possibility of rotating in the said body-casing and in communication with the interior of the device, which closes inferiorly while being impregnated with the existing paint in the device; at least one, and preferably two brushes mounted fixedly in the body casing accompanying the impeller or impellers deposit the paint on the surface to be painted, said paint being immediately distributed by either or both brushes.

This roller has several disadvantages, such as not being useful for painting a ceiling, because the device would be upside-down and it would be very difficult for the paint to make contact with the roller, nor is it helpful to paint elevated walls as the paint will be aggregate in the bottom of the body-casing by mean of the gravity, so it seem that the roller is suitable for horizontal surfaces and perhaps perpendicular; it is very likely that the output of the paint would be obstructed by solid impurities that permeate the roller brush, including lumps coming from the paint; wile painting, pressure is exerted on said roller and this easily seal off the paint output of the body-shell, as the roller closes said paint exit and with a light pressure, it would be close. Moreover, it is unclear if the brush travels longitudinally along the body-casing.

Therefore, to counteract the disadvantages mentioned above was developed an improved paint roller which has a precise and controlled flow of paint and works independently of its position because all its components make the painting more even, easy and simple, as it has no reservoir of paint and the painter's arm will not load a greater weight while painting.

### DESCRIPTION OF THE INVENTION

The detailed characteristics of the present improved roller for painting difficult-to-access rough surfaces, which are described below and are illustrated by the drawings, are cited as an example and should not be considered as limitative.

### BRIEF DESCRIPTION OF THE FIGURES:

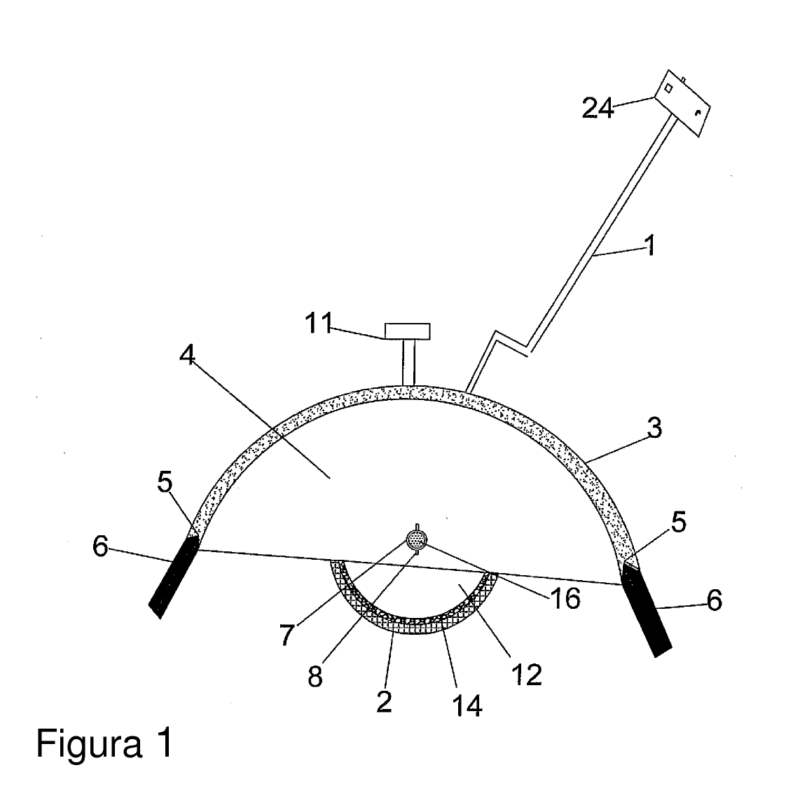

The FIG. 1 is a side view of the roller for painting difficult-to-access rough surfaces, the present invention.

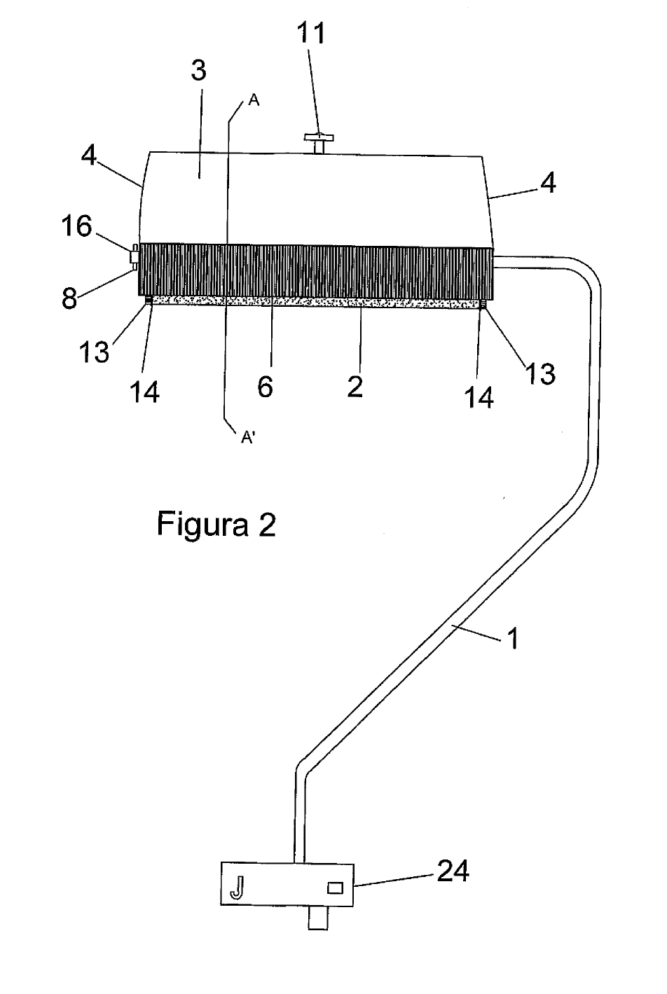

The FIG. 2 is a front view of the roller for painting difficult-to-access rough surfaces in question.

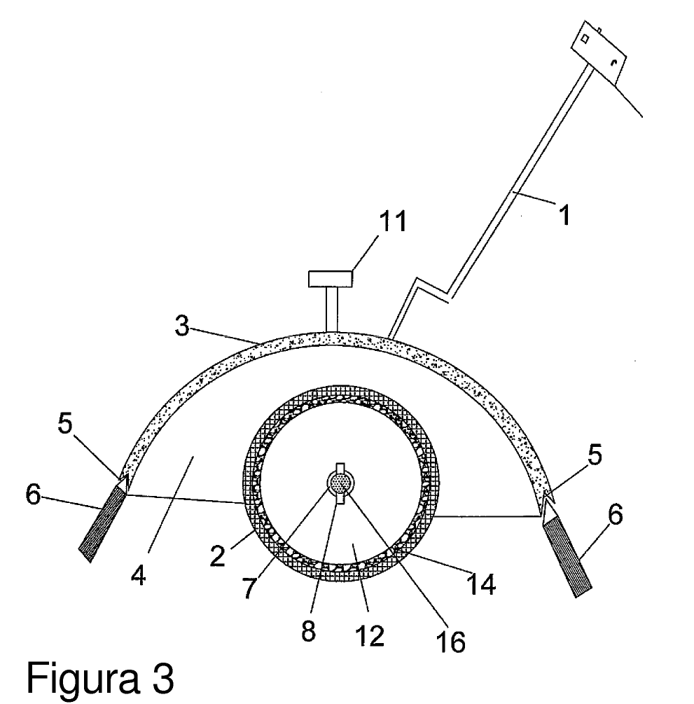

The FIG. 3 is an A-A′ cross-sectional view of roller in question.

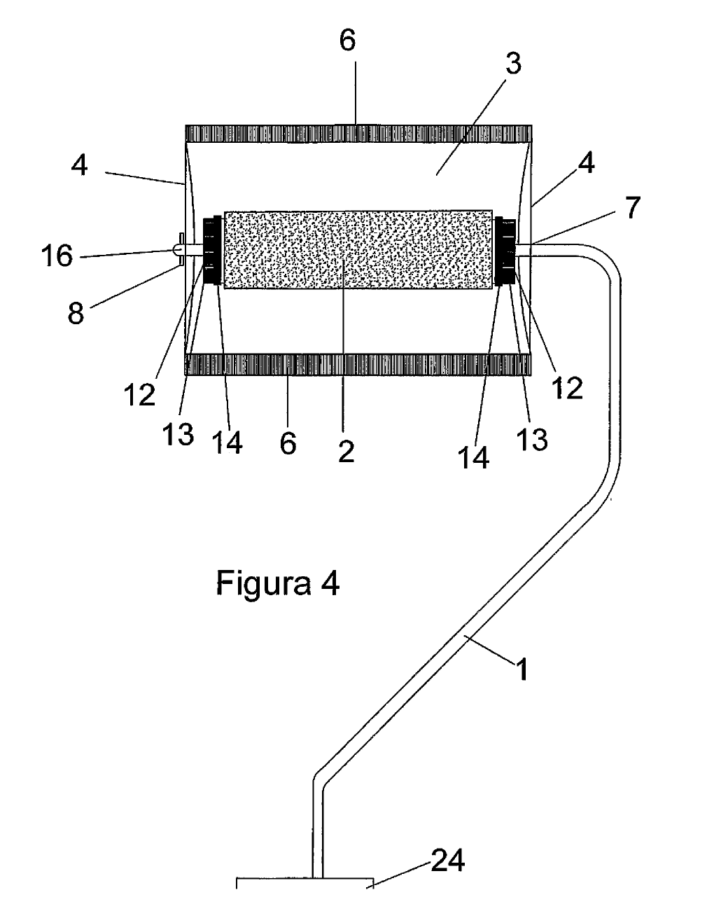

The FIG. 4 is a bottom view of the roller for painting difficult-to-access rough surfaces in question

The FIG. 5 is a front view of the roller, in one of its embodiment, when the body is opened on its sides.

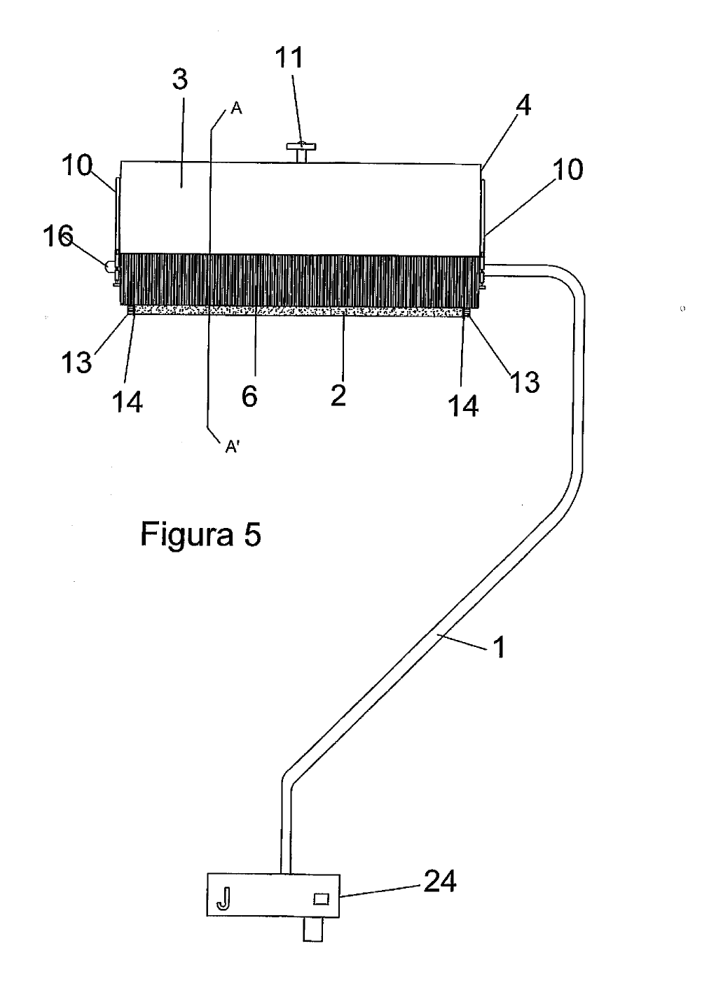

The FIG. 6 is a side view of the embodiment of the FIG. 5.

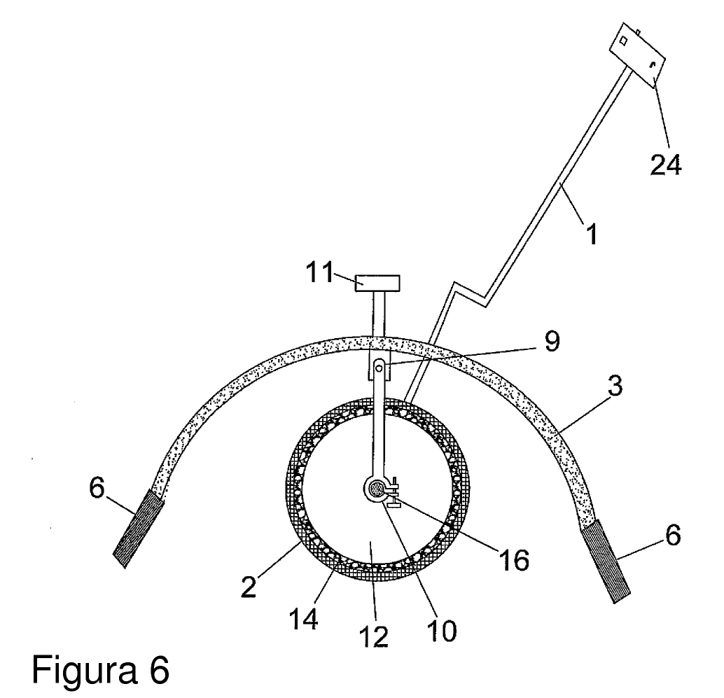

The FIG. 7 is a front view of the roller in its embodiment of the FIGS. 5 and 6, but without the casing.

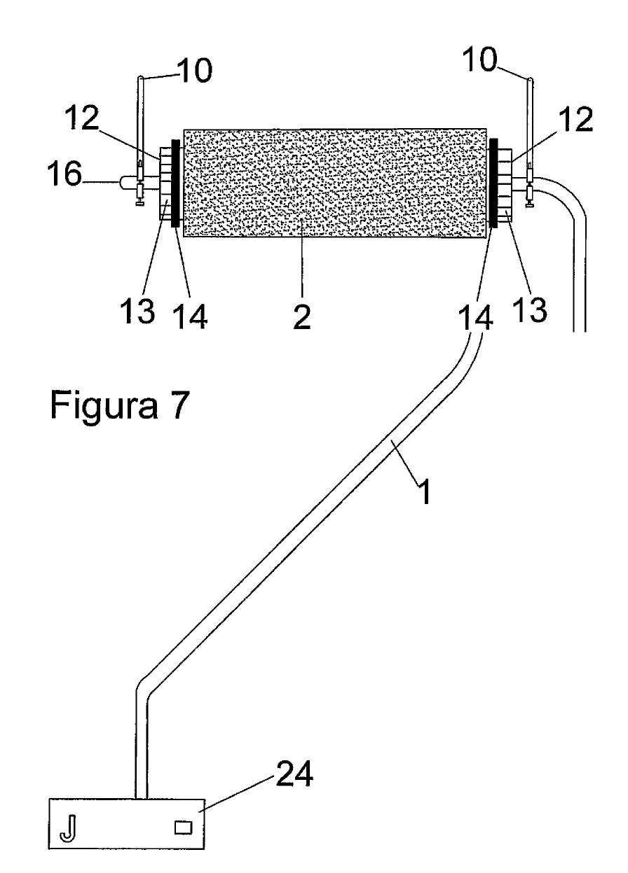

The FIG. 8 is a side view of the roller in question, but in its embodiment of two rollers.

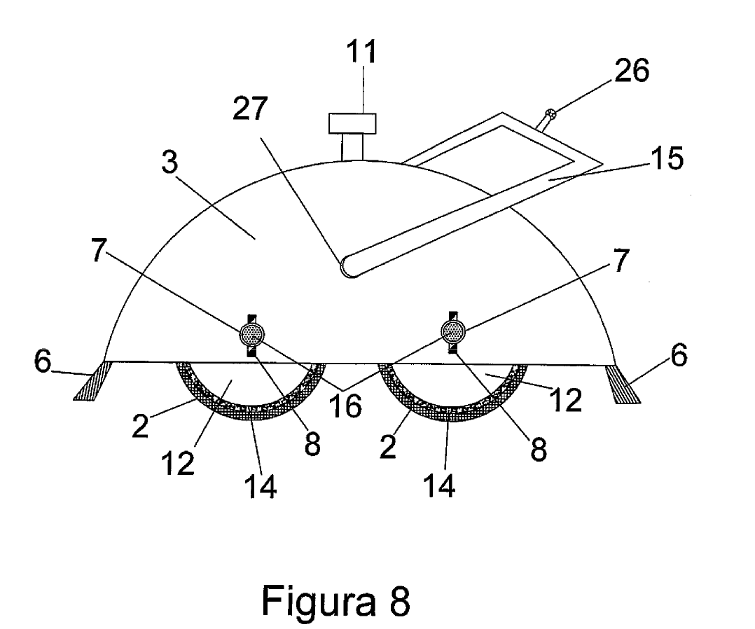

The FIG. 9 is a top view of the paint roller, in its embodiment of two rollers.

The FIG. 10 is a bottom view of the of the paint roller, in its embodiment of the FIG. 9.

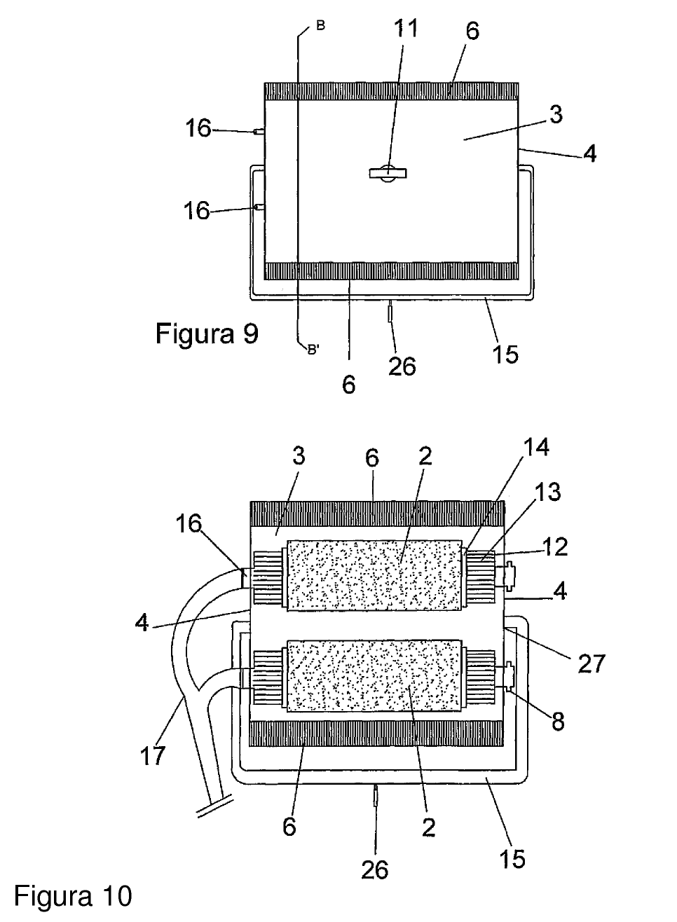

The FIG. 11 is a B-B′ cross-sectional view of the two rollers embodiment.

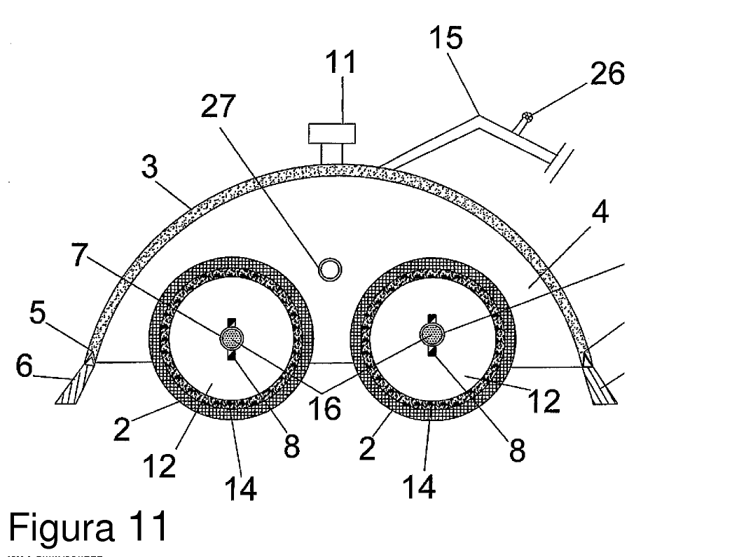

The FIG. 12 is an exploded cross-sectional view of the extensible and/or retractable handle of the roller, in its embodiment of one roller.

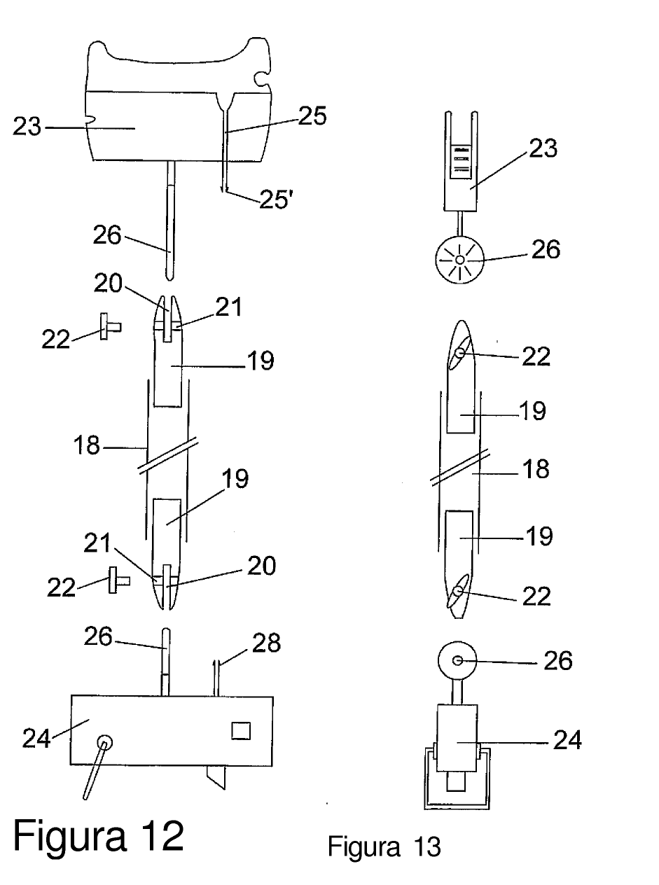

The FIG. 13 is an exploded side view of the extensible and/or retractable handle of the roller, in its embodiment of one roller.

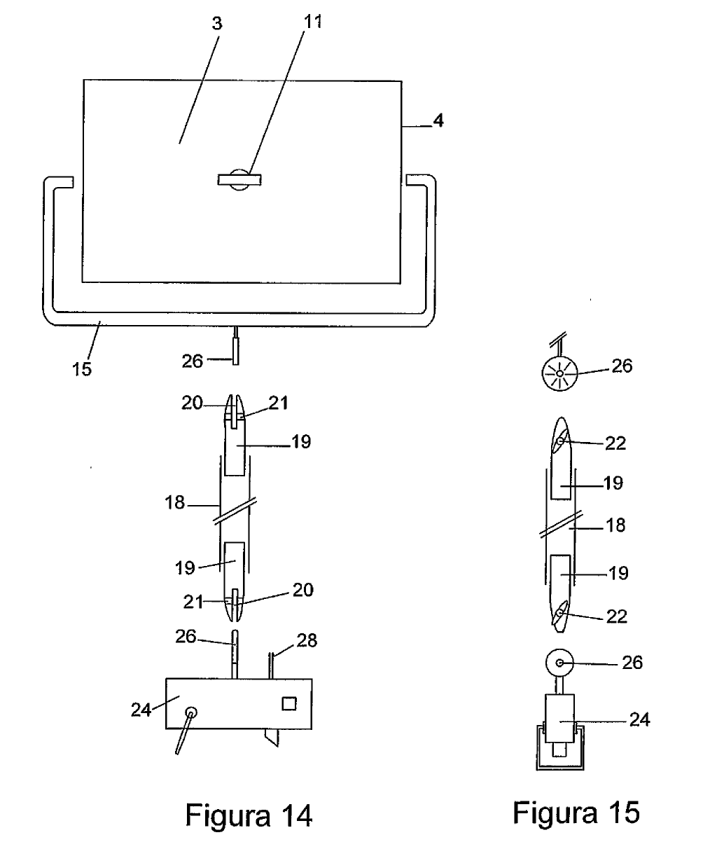

The FIG. 14 is an exploded front view of the extensible and/or retractable handle of the roller, in its embodiment of two rollers.

The FIG. 15 is an exploded side view of the extensible and/or retractable handle of the roller, in its embodiment of two rollers.

The present invention is focused on those conventional rollers which have a mechanism to provide paint, such as the one described in the patent application PCT/MX2008/000033, where said roller is composed of a tube 1 which supports the roller plush 2, so the painting continues its way through the tube 1 to a series of small perforations (not shown) that are located on the opposite end of tube 1, so this extremity should be closed, as to force the paint out through the perforations and moisten the roller plush. The modification is that three-quarters of the diameter of said roller is inside a casing 3 in a half pipe form, which may or may not close its side panels 4, but is open at its bottom. In the longitudinal edges of the housing 3 there is a “V” shaped canal 5 where is inserted a strip or base of bristles 6.

The casing 3 provides a perforation 7 in its lateral sides 4, through which enters the tube 1 which holds the roller, so obviously there is a need for a fastening mechanism 8, such as a fastener, clasp, bolts, etc.

When the housing 3 has its lateral sides opened, in other words having no sides 4, to said housing is added on top of each lateral sides a means of securing 9 to support an arm 10 connecting the housing to the tube 1 of the roller 2. Where said arm 10 has vertical movement and should allow the roller to rotate on its own axis.

The housing have or have not, in the center of its external superior part, a counterweight 11, whose function is to make the bristles of the housing come into contact with the surface to paint, especially when such surfaces are walls and similar buildings.

In this case the roller 2 has at its extremities a pierced cover 12, to prevent paint from spilling by these extremities. The stoppers can have a rough section 13 for grip when place or remove the roller and a circular ledge 14 that demarcate the space of the plush as to prevent it from moving.

In the casing you can add more than a roller, in this case the tube 1 which holds the plush disappear, with the exception of its drilled extremity 16 where the paint exit to moisten the plush.

Additionally, more perforations 7 are made in the housing 3 to hold the perforated pipe 16. Also, an open frame 15 is added externally to the casing to hold it, and is attached to the casing through its tips that enters in the openings 27 located in the sides 4 of the housing. It is worth mentioning that the perforated pipe 16 is supported so it can rotate on its own axis. For its part, the open frame 15 allows the casing to have a rotary motion around its own axis as well. In one end of the perforated pipe 16 is opened to connect a conduct 17 that provides the paint, which comes from a conventional paint supply mechanism, similar as those described in the documents PCT/MX2006/000076 and PCT/MX2008/000033.

Another feature of this roller is to have an extendable or retractable handle, which is made of tubular bars 18 similar to the ones of a telescope. At each end of the tubular bars fits a connector 19, which has a vertical slot 20 on its tip and a horizontal duct 21 where a clamp 22 goes through.

To connect the handle to the roller, other connector accessories are required, for example to connect to the housing that has a roller, requires a receptacle 23 for the roller base 24. Where the receptacle has a paint conduit 25 where is introduced the lower end of tube 1 that holds the roller; the paint conduit 25 is projected outwardly to the bottom of the receptacle 23 in a tube 25′ where is connected the hose or conduct 17 where the paint goes through. In the bottom of the receptacle 23 there is a rounded piece 26 which is the one being introduced into the vertical slot 20 to be fastened with fastening means 22, which passes through the horizontal duct 21 and the rounded piece 26.

The rounded piece is striated to give the roller angular positions. To connect the handle to the source of paint, it requires another base 24 to which is added on the top another piece similar to the rounded piece 26 described above; and a tube 28 is placed on its top to connect the hose 17, as shown in FIGS. 12 and 13.

Now for connecting the handle to a casing which has more than one roller, see FIGS. 14 and 15, the rounded piece 26 is connected to the center of bottom of the open frame 15. In this case, the supply of paint is through the hose 17, which comes from tube 28 of the base 24 and branches, according to the number of rollers, to connect to the open end of the perforated tube 16.

The operation of the roller is user-friendly as being coupled to a casing with bristle improves the distribution of the paint, as in going through elevated, difficult-to-access and rough walls, the painter can paint more evenly with a few passes, as the contact of the roller or of the rollers on these areas will be accompanied by bristles, which will cause the paint to penetrate rough areas or areas inaccessible to the roller, moreover the conjoint use of roller and bristles means a saving of time, of effort and of paint, with the added benefit of having its casing serves as a protection against paint splash on ceilings or walls.

The painter, additionally to painting with the roller in low-lying areas, can also use the extensible and/or retractable handle, which is very easy to use thanks to its telescopic form and low weight, allowing him to reach elevated ceilings. It is very lightweight thanks to the materials of both the handle, the roller and the casing, making it suitable for painting as the painter don't have to carry a lot of weight in his arms, moreover a painting supply mechanism is provided for coupling conventional paint supplier or any desired supply mechanism.

Having sufficiently described my invention, and this being a novelty, I claim as my exclusive property, the content described in the following 5 clauses:

1. A roller for painting difficult-to-access surfaces, which is formed of a paint supplying mechanism and of a tubular structure 1 closed, conventional, which holds a plush 2 in its horizontal extremity, where the portion covering the plush 2 of said horizontal extremity is perforated, where plush 2 have in each of its ends a cap 12, which has a central perforation so the tube 1 can be passing through said perforation and a circular edge 14 that delimit the space of the plush 12, and an extendable and/or retractable handle, which is added in the bottom of the tubular structure.
Said roller is characterized by comprising a connector base 24 between the junction of the base of the structure and the expandable and/or retractable handle, where said connector base 24 has the means to have inserted on it the base of the structure, means to have the paint pass through and means to have in its turn the base connector 24 inserted into a receptacle 23, which is bound to the extensible and/or retractable handle.

1. A roller for painting difficult-to-access surfaces, which is formed of a paint supplying mechanism and of a tubular structure 1 closed, conventional, which holds a plush 2 in its horizontal extremity, where the portion covering the plush 2 of said horizontal extremity is perforated, where plush 2 have in each of its ends a cap 12, which has a central perforation so the tube 1 can be passing through said perforation and a circular edge 14 that delimit the space of the plush 12, and an extendable and/or retractable handle, which is added in the bottom of the tubular structure.
Said roller is characterized by comprising a connector base 24 between the junction of the base of the structure and the expandable and/or retractable handle, where said connector base 24 has the means to have inserted on it the base of the structure, means to have the paint pass through and means to have in its turn the base connector 24 inserted into a receptacle 23, which is bound to the extensible and/or retractable handle.

2. The roller of claim 1, characterized in that the cap 12 has a rough section 13 for grip when placed or removed from the roller.

3. The roller of the precedent claims, characterized in that the receptacle 23 has a conduit of paint 25 where is introduced the inferior extremity of the tube 1 which holds the roller; the paint conduit 25 is projected externally and downwards the receptacle 23 in a tube 25 where is connected the hose or conduit 17 where the paint passes through. At the bottom of the receptacle 23 there is a rounded piece 26 which is inserted into the vertical slot 20 to be fastened with fastening means 22, which passes through the horizontal duct 21 and the rounded piece 26. The rounded piece is striated to give the roller angular positions.

4. The roller of the preceding claims, characterized in that it includes an open housing 3, shaped in a half pipe form, that covers three-quarters of the diameter of the tube (plush), where said housing have in its lateral sides 4, at least, a hole 7 through which passes the tube 1, a “V” shaped canal 5 is its lateral sides where is inserted a strip or bristle base 6; a counterweight 11 in its external central superior part, to makes the bristle of the housing come into contact with the surface to paint, especially when these are walls or similar constructions.

5. The roller of claim 4, characterized in that is added on the superior part of the base 24 a second rounded piece 26 and a tube 28 to connect the expandable and/or retractable handle the conduit 17 from which come through the paint.

6. The roller of the preceding claims, 4 and 5, characterized by, when the housing 3 has its lateral extremity open, is added on top of each lateral extremity, a means of attachment 9 to support an arm 10 that connects the housing to the tube 1 of the roller 2, where said arm 10 has vertical movement and must allow the roller to rotate on its own axis.

7. The roller of the claims 4, 5 and 6, characterized in that to the housing 3 is added more than a roller, for which the tube 1 that holds the plush disappear, with the exception of the perforated extremity 16 where exits the paint to moisten the plush, where the perforated tubes 16 pass through the perforations 7 of the housing 3; also to said housing is externally added an open frame 15, to sustain it, which is attached to the housing by means of its points entering perforations 27 located in the sides 4 of the housing. The Perforated tubes 16 are held in such a way that they can rotate on their own axis, while the case is held to the open frame 15, in such a way that allow it to have rotary motion about its own axis as well. One end of the perforated pipes 16 is open to connect a conduit 17 which provides the paint, which comes from a conventional paint supplying mechanism 15.

8. The roller of the claim 7, characterized in that is connected to the central inferior part of the open frame 15 a rounded piece 26 for connecting the expandable and/or retractable handle.

9. The roller of the claims 4, 5, 6, 7 and 8, characterized in that the conduit 17 is coming from the tube 28 of the base 24 and its opposite extremity to the end which is attached to the tube 28 branches according to the number of rollers, to connect each branch to the open extremity of a perforated tube 16.
